(19) United States
(12) Patent Application Publication
(10) Pub. No.: US 2010/0118439 A1
(43) Pub. Date: May 13, 2010

(54) MAGNETIC HEAD AND INFORMATION STORAGE APPARATUS

(75) Inventor: Kenichiro Aoki, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/569,277

(22) Filed: Sep. 29, 2009

(30) Foreign Application Priority Data
Nov. 11, 2008 (JP) 2008-288808

(51) Int. Cl. G11B 5/127

(52) U.S. Cl. 360/125.01; G9B/5.04

(57) ABSTRACT

According to one embodiment, a magnetic head includes: a coil configured to be supplied with current; a main magnetic pole configured to be disposed along one surface of the coil and extend in a direction orthogonal to a floating surface from the floating surface; at least one auxiliary magnetic pole configured to be disposed along other surface of the coil and parallel to the main magnetic pole; a connecting portion configured to be linked with the coil and connect the main magnetic pole and the auxiliary magnetic pole; and a radiating layer configured to be disposed between the coil and the auxiliary magnetic pole and have larger thermal conductivity than the auxiliary magnetic pole.

### CROSS-REFERENCE TO RELATED APPLICATIONS

This application is based upon and claims the benefit of priority from Japanese Patent Application No. 2008-288808, filed Nov. 11, 2008, the entire contents of which are incorporated herein by reference.

### BACKGROUND

1. Field

One embodiment of the invention relates to a magnetic head that records information represented by magnetization on a storage medium, and an information storage apparatus including the magnetic head and the storage medium.

2. Description of the Related Art

In recent years, with the development of computer technology, technologies for apparatuses incorporated in a computer or peripheral apparatuses externally connected to the computer have been rapidly developed. As one of the technologies, an information storage apparatus that rotates a storage medium having a planar shape, such as a magnetic disk, forms an arrangement of magnetization representing information on the storage medium to storage the information, and reads a magnetization direction from the storage medium to reproduce the information is known. A hard disk device (HDD) is a representative example of the information storage apparatus, and a magneto optical (MO) disk device is known as another example.

Among the information storage apparatuses, there is an information storage apparatus that draws a magnetic head having a recording element near a surface of a storage medium to form magnetization on the storage medium. The recording element has a record coil (hereinafter, referred to as write coil). When the information is recorded, a record signal is input to the recording element, and a current based on the record signal flows through the write coil. A magnetic field is generated in the write coil due to the current, the generated magnetic field is applied to a surface of the storage medium through a predetermined magnetic pole, and magnetization is generated in the storage medium in a direction according to a direction of the magnetic field.

When the current flows through the write coil, the Joule heat is generated due to electrical resistance of the write coil. If a temperature of a peripheral portion of the recording element is increased due to the generated heat, the peripheral portion of the recording element protrudes toward the surface of the storage medium due to a thermal expansion of a surrounding material of the recording element. As such, if the peripheral portion of the recording element protrudes toward the surface of the storage medium, the storage medium contacts the magnetic head, which may result in damaging the storage medium. For this reason, conventionally, a radiating member having high thermal conductivity is attached to an outflow end side of the recording element to discharge heat to the outside of the recording element. Next, an example of the magnetic head according to the related art that comprises the radiating member provided at the outflow end side of the recording element will be described.

FIG. 1 is a cross-sectional view of the structure of a magnetic head 1′ that has a radiating member 107′ provided at the side of an outflow end of a recording element 1b′.

The magnetic head 1′ of FIG. 1 floats a floating surface at a minute distance from a magnetic disk 5 toward the magnetic disk 5 rotating in arrow direction of FIG. 1. In FIG. 1, an upper surface of the magnetic head 1′ expanding in a horizontal direction (line extending in the horizontal direction in FIG. 1) is a floating surface that faces the side of the magnetic disk 5, when the magnetic head 1′ is approached to the magnetic disk 5. The magnetic head 1′ forms an arrangement of magnetization representing information on the magnetic disk 5 using the recording element 1b′ to record information, and reads a direction of the magnetization formed on the magnetic disk 5 using a reproducing element 1a to reproduce information. The magnetic head 1′ further includes a heater 103 to adjust a distance from the floating surface of the magnetic head 1′ to the magnetic disk 5. In the magnetic head 1′ of FIG. 1, the structure where the reproducing element 1a, the heater 103, and the recording element 1b′ are sequentially laminated on a slider 2 through insulating alumina 105 along the floating surface of the magnetic head 1′ is provided.

The reproducing element 1a has the configuration where a magnetoresistive effect film 102 having an electric resistance varying according to the direction of the applied magnetic field is interposed between two magnetic shields 101, and the direction of the magnetization of the magnetic disk 5 is detected by the magnetoresistive effect film 102.

The recording element 1b′ includes a double coil 109 functioning as a write coil, and the double coil 109 includes two coil portions of a first coil portion 109a and a second coil portion 109b that have different winding directions, but are configured using the same one winding. In FIG. 1, with respect to each of the first coil portion 109a and the second coil portion 109b, 6 coil sections that are arranged in a vertical direction are illustrated. In this case, around the first coil portion 109a and the second coil portion 109b, an insulating resin 108 is filled. The double coil 109 includes a connection coil portion 109c configured using a winding connecting the two coil portions, between the first coil portion 109a and the second coil portion 109b. An inversion of winding directions between the winding direction of the winding in the first coil portion 109a and the winding direction of the winding in the second coil portion 109b is made by the connection coil portion 109c.

The recording element 1b′ includes a main magnetic pole 104, a first auxiliary magnetic pole 106a, a second auxiliary magnetic pole 106b, and a connecting portion 106c, which are formed of a ferromagnetic material. In this case, a front end of the first auxiliary magnetic pole 106a is provided with a trailing shield 106d that extends in the horizontal direction of FIG. 1. In the recording element 1b′, the connecting portion 106c is wound by the first coil portion 109a. If a current flows through the first coil portion 109a, a magnetic flux that passes through the main magnetic pole 104, the connecting portion 106c, and the first auxiliary magnetic pole 106a is generated due to the current. As described above, since the first coil portion 109a and the second coil portion 109b are configured using the same one winding, a current that flows through the first coil portion 109a also flows through the second coil portion 109b. Due to the current that flows through the second coil portion 109b, another magnetic flux that passes through the main magnetic pole 104 and the second auxiliary magnetic pole 106b is generated. As described above, since the winding directions of the winding in the first coil portion 109a and the second coil portion 109b are opposite to each other, a magnetic field that is generated due to the current flowing through the first coil portion 109a and the second coil portion 109b becomes a magnetic field that is oriented in the same direction in the main magnetic pole 104. A magnetic field that is obtained by synthesizing the magnetic fields is applied from the main magnetic pole 104 to the magnetic disk 5. At this time, magnetization of the same direction as the magnetic field is formed in the magnetic disk 5 due to the magnetic field applied to the magnetic disk 5.

The recording element 1b′ includes a radiating layer 107′ provided on a surface of the first auxiliary magnetic pole 106a, which is opposite to the side of the main magnetic pole 104 and faces the outflow end side of the recording element 1b′. The Joule heat that is generated in the double coil 109 due to the current flowing through the double coil 109 is transmitted to the radiating layer 107′, and diffuses in a direction (downward direction in FIG. 1) that is opposite to the floating surface along the radiating layer 107′. In this case, the radiating layer 107′ is disposed at a place distant from the double coil 109 where the heat is generated. However, if the amount of heat generated in a unit time is small, before a large amount of heat is accumulated around the double coil 109, the heat is transmitted to the radiating layer 107′, and is difficult to be efficiently discharged from the radiating layer 107′ to the outside of the recording element 1b′. The radiating layer 107′ maybe preferably disposed on the side of the outflow end of the recording element 1b′, which is distant from the double coil 109.

Meanwhile, the heat that is generated in the recording element includes the Joule heat that is generated in the write coil due to the current flowing through the write coil and the Joule heat that is generated due to an overcurrent generated in a magnetic path of the magnetic field generated by the current. The overcurrent that is induced by a temporal variation of the magnetic field holds a spiral current path surrounding the magnetic path of the magnetic field. The overcurrent is large on the surface of the magnetic pole in particular, and flows through the surface of the magnetic pole to surround the magnetic pole. At this time, on the surface of the magnetic pole, the Joule heat due to the overcurrent is generated.

FIG. 2 illustrates a variation in the Joule heat due to a current of a write coil and a variation in the Joule heat due to an overcurrent, when a frequency of the current flowing through the write coil is increased.

FIG. 2 illustrates a graph of the Joule heat due to the current of the write coil and a graph of the Joule heat due to the overcurrent, when it is assumed that a horizontal axis indicates a frequency (GHz) of the current flowing through the write coil an a vertical axis indicates a heat power (mW) per unit time. As illustrated in FIG. 2, when the frequency is low, since the heat power of the Joule heat due to the overcurrent is significantly smaller than the heat power of the Joule heat due to the current of the write coil, the heat power of the Joule heat may be ignored. In this case, in theory, the Joule heat due to the overcurrent rapidly increases proportional to approximately the square of the frequency of the current flowing through the write coil, and the Joule heat due to the current of the write coil moderately increases as compared to the Joule heat due to the overcurrent. As a result, as illustrated in FIG. 2, when the frequency of the current flowing through the write coil increases, a difference between the Joule heat due to the current of the write coil and the Joule heat due to the overcurrent decreases. If the frequency of the current flowing through the write coil approximates to about 1.3 GHz, the difference becomes almost zero. If the frequency exceeds 1.3 GHz, the Joule heat due to the overcurrent exceeds the Joule heat due to the current of the write coil. In particular, if the frequency is 1.5 GHz or more, the frequency increases and the Joule heat due to the overcurrent rapidly increases. Meanwhile, the Joule heat due to the current of the write coil does not increase by the corresponding amount, and the large heat power is not generated.

In recent years, in a field of an information storage apparatus, it is strongly required to decrease a time needed to store information. Due to this request, in the field of the information storage apparatus, a magnetization forming speed is increased by increasing the frequency of the current flowing through the write coil and temporally varying the magnetic field applied from the recording element to the storage medium at a high speed. In a current information storage apparatus, the frequency of the current flowing through the write coil is about several hundreds of megahertz, but it is anticipated that the frequency approximates to 1.5 GHz or more in the future. As supposed from FIG. 2, at the frequency of 1.5 GHz or more, a heat power of the Joule heat due to the overcurrent becomes significantly larger than that of the Joule heat due to the current of the write coil, and the Joule heat due to the overcurrent needs to be prevented from being accumulated around the recording element.

Meanwhile, as illustrated in FIG. 1, in a system where the radiating layer is disposed on the outflow end side of the recording element, in the case of the small heat power like the Joule heat due to the current of the write coil, the heat can be sufficiently discharged from the radiating layer to the outside of the recording element. However, if the heat power is large as in the Joule heat due to the overcurrent, before the heat is transmitted to the radiating layer, the peripheral portion of the recording element may unintentionally protrude to the surface of the storage medium. In this case, a system (so-called DFH control) where the peripheral portion of the recording element intentionally protrudes to the surface of the storage medium by controlling a heater provided near the recording element is generally known. However, if an unintentional protrusion due to the overcurrent overlaps an intentional protrusion due to the DFH control, the possibility of the peripheral portion of the recording element contacting the surface of the storage medium increases.

In general, the Joule heat due to the overcurrent is inversely proportional to the resistivity of a member where the overcurrent is generated. Accordingly, it is considered that a magnetic pole is formed of a material having large resistivity in order to suppress the Joule heat due to the overcurrent (for example, refer to Japanese Patent Application Publication (KOKAI) Nos. 2001-68336 and H11-175913 and U.S. Pat. No. 7,190,552). For example, in the magnetic head 1′ of FIG. 1, if each of the main magnetic pole 104, the first auxiliary magnetic pole 106a, the second auxiliary magnetic pole 106b, and the connecting portion 106c is formed of a material having large resistivity, the Joule heat due to the overcurrent can be decreased to some degree. In general, since the overcurrent serves to suppress a variation in the magnetization of the magnetic pole in terms of control, the magnetization of the magnetic pole does not follow the control current, which may result in deteriorating recording performance. As described above, if the magnetic pole is formed of the material having the large resistivity, the overcurrent decreases, and the deterioration of the recording performance can be suppressed to some degree.

In general, the material of the magnetic pole preferably has a high saturation magnetic flux density. For example, as the material of the magnetic pole, an alloy (Ni—Fe) of nickel (Ni) or iron (Fe) that has a high saturation magnetic flux density may be used. From a viewpoint of a use as the magnetic pole, when the material of the magnetic pole is determined, it is needed to consider a material having a high saturation magnetic flux density as a matter of the highest priority. For this reason, in a countermeasure that suppresses the Joule heat due to the overcurrent by varying the material of the magnetic pole, a material having relatively high resistivity needs to be selected from the materials having a high saturation magnetic flux, and a width of options is narrow. For this reason, in this countermeasure, in a high frequency domain where the frequency of the current flowing through the write coil is extremely high, it is difficult to sufficiently suppress the Joule heat due to the overcurrent.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary cross-sectional view of a magnetic head that has a radiating member having high thermal conductivity at an outflow end side of a recording element;

FIG. 2 is an exemplary graph of a variation in the Joule heat due to a current flowing through a write coil and a variation in the Joule heat due to an overcurrent, when a frequency of the current is increased;

FIG. 3 is an exemplary schematic diagram of a HDD that is an information storage apparatus according to a first embodiment of the invention;

FIG. 4 is a block diagram of a control board in the first embodiment;

FIG. 5 is an exemplary schematic diagram of a head illustrated in FIGS. 3 and 4 in the first embodiment;

FIG. 6 is an exemplary cross-sectional view of the head illustrated in FIG. 5 in the first embodiment;

FIG. 7 is an exemplary graph of the Joule heat for each magnetic pole that is generated due to an overcurrent in the first embodiment;

FIG. 8 is an exemplary graph of a simulation result in the first embodiment;

FIG. 9 is an exemplary cross-sectional view of a head in a head slider according to a second embodiment of the invention;

FIG. 10 is an exemplary graph of the Joule heat for each magnetic pole that is generated due to an overcurrent in the second embodiment;

FIG. 11 is an exemplary graph of a simulation result in the second embodiment;

FIG. 12 is an exemplary cross-sectional view of a head slider according to a third embodiment of the invention;

FIG. 13 is an exemplary graph of the Joule heat for each magnetic pole that is generated due to an overcurrent of a recording element of FIG. 12 in the third embodiment;

FIG. 14 is an exemplary cross-sectional view of a head in a head slider according to a fourth embodiment of the invention;

FIG. 15 is an exemplary cross-sectional view of a head in a head slider according to a fifth embodiment of the invention;

FIG. 16 is an exemplary cross-sectional view of a head in a head slider according to a sixth embodiment of the invention;

FIG. 17 is an exemplary cross-sectional view of a head in a head slider according to a seventh embodiment of the invention; and

FIG. 18 is an exemplary cross-sectional view of a head in a head slider according to an eighth embodiment of the invention.

### DETAILED DESCRIPTION

Various embodiments according to the invention will be described hereinafter with reference to the accompanying drawings. In general, according to one embodiment of the invention, a magnetic head includes: a coil configured to be supplied with current; a main magnetic pole configured to be disposed along one surface of the coil and extend in a direction orthogonal to a floating surface from the floating surface; at least one auxiliary magnetic pole configured to be disposed along other surface of the coil and parallel to the main magnetic pole; a connecting portion configured to be linked with the coil and connect the main magnetic pole and the auxiliary magnetic pole; and a radiating layer configured to be disposed between the coil and the auxiliary magnetic pole and have larger thermal conductivity than the auxiliary magnetic pole.

According to another embodiment of the invention, a magnetic head includes: a coil configured to be supplied with current and composed of a spirally wound winding; a main magnetic pole configured to be linked with the coil and extend in a direction orthogonal to a floating surface from the floating surface; at least two auxiliary magnetic poles configured to face the main magnetic pole with a portion of the winding constituting the coil therebetween and be disposed parallel to the main magnetic pole; a connecting portion configured to connect the main magnetic pole and the auxiliary magnetic poles; and a radiating layer configured to be disposed between the coil and the main magnetic pole and have larger thermal conductivity than the main magnetic pole.

According to still another embodiment of the invention, an information storage apparatus includes: a storage medium; and a magnetic head configured to record information represented by magnetization on the storage medium, wherein the magnetic head includes: a coil configured to be supplied with current; a main magnetic pole configured to be disposed along one surface of the coil and extend in a direction orthogonal to a floating surface from the floating surface; at least one auxiliary magnetic pole configured to be disposed along the other surface of the coil and parallel to the main magnetic pole; a connecting portion configured to be linked with the coil and connect the main magnetic pole and the auxiliary magnetic pole; and a radiating layer configured to be disposed between the coil and the auxiliary magnetic pole and have larger thermal conductivity than the auxiliary magnetic pole.

A magnetic head and an information storage apparatus according to various embodiments will be described hereinafter with reference to the accompanying drawings.

First, a first embodiment will be described.

FIG. 3 illustrates a hard disk device (HDD) 10 that is an information storage apparatus according to the first embodiment.

The HDD 10 illustrated in FIG. 3 is provided with a voice coil motor 4 where a voice coil (not illustrated) functioning as a movable coil and a permanent magnet (not illustrated) applying a constant magnetic field to the voice coil are incorporated. In the voice coil motor 4, a current flows through the voice coil to move the voice coil, and a rotation driving force around a shaft 40 is generated by the movement of the voice coil. An arm 3 receives the rotation driving force of the voice coil motor 4 and rotates around the shaft 40. In a front end of the arm 3, the slider 2 is mounted by a support called gimbal. In a front end of the slider 2, a head 1 is mounted. A head slider that is formed by combining the head 1 and the slider 2 is a magnetic head according to the first embodiment.

The head 1 reads information from the magnetic disk 5 or records information on the magnetic disk 5. When the information is read or recorded, the arm 3 rotates around the shaft 40 by the voice coil motor 4. By this rotation, the head 1 moves in a radial direction of the magnetic disk and is positioned at a target head position (desired head position) to record or read information, with respect to the radial direction of the magnetic disk. In this case, the head 1 that is positioned at the desired position is maintained at a position that floats from a surface of the magnetic disk 5 having a disc shape by a minute height. In FIG. 3, the head 1 is illustrated in a xyz orthogonal coordinate system where a central direction of the magnetic disk 5 is defined as a y axis and a normal direction is defined as a z axis, using a position of the head 1 as an original point.

On the surface of the magnetic disk 5 that has the disc shape, a structure where tracks rotating around the disk are arranged in a radial direction is provided. In FIG. 3, among the tracks, one track 50 is illustrated. As illustrated in FIG. 3, a plurality of servo areas 52 that extend between the rotation central side of the magnetic disk 5 and the circumferential side of the magnetic disk 5 are provided on the surface of the magnetic disk 5 having the disc shape. In each servo area 52 that is an area where positioning information of the head 1 is stored, positional information (address information) that indicates a position in the radial direction or a position in the circumferential direction is recorded. As illustrated in FIG. 3, each of the servo areas 52 has a curved shape obtained by drawing a moderate arc, and the curved shape depends on a trace of the position of the head 1 of when the head 1 moves on the magnetic disk 5 by the rotation of the voice coil motor 4. An area between the two servo areas 52 in the track 50 is an area called a data sector, and a data sector 51 is a data area for recording and reading information handled by a user (hereinafter, simply referred to “data”). In the servo area 52 or the data sector 51, magnetization that is oriented in a positive direction or a negative direction of the z axis of FIG. 3 is generated. By the two directions, two values of “0” and “1” are represented and information of one bit is realized.

The head 1 has two elements that are a recording element (not illustrated in FIG. 3) to record information on the magnetic disk 5 and a reproducing element (not illustrated in FIG. 3) to read information from the magnetic disk 5. The reproducing element includes a magnetoresistive effect film where a resistance value varies according to a direction of an applied magnetic field. When the data or the positional information is reproduced, the reproducing element detects when a value of current flowing through the magnetoresistive effect film varies according to the magnetic field generated by the magnetization, and extracts information displayed by the direction of the magnetization. A signal that indicates a variation of the current is a reproduction signal that indicates the extracted information, and the reproduction signal is output to a head amplifier 8. The recording element includes a magnetic pole and a coil functioning as an electromagnet. When the data is recorded, an electrical record signal that represents data by a bit value is input through the head amplifier 8 to the recording element of the head 1 approached to the magnetic disk 5, and the recording element flows a current of a direction according to the bit value of the record signal into the coil. The magnetic field that is generated in the coil by the current is applied to the magnetization on the magnetic disk 5 through the magnetic pole, and a magnetization direction is aligned to the direction according to the bit value of the record signal. As a result, the data that is carried by the record signal is recorded in a format of the magnetization direction.

The magnetic disk 5 receives the rotation driving force of a spindle motor 9 and rotates in the plane of FIG. 3. The head 1 sequentially approaches to the servo areas 52 arranged in the circumferential direction by the rotation of the magnetic disk 5, and reads the positional information. On the basis of the read result, the head 1 is positioned at the position of the desired data sector 51 with respect to the radial direction of the magnetic disk 5, by the rotation of the voice coil motor 4. When the head 1 is approached to the desired data sector 51 by the rotation of the magnetic disk 5 after the head 1 is positioned, data is recorded or reproduced.

The individual components, such as the voice coil motor 4, the arm 3, the slider 2, the head 1, and the head amplifier 8, which are directly associated with the storage and reproduction of the information, are accommodated in a base 6 together with the magnetic disk 5. In FIG. 3, an internal aspect of the base 6 is illustrated. The rear side of the base 6 is provided with a control board 7 that has a control circuit to control driving of the voice coil motor 4 or access by the head 1. In FIG. 3, the control board 7 is illustrated by a dotted line. In the HDD 10, the individual components of the base 6 at the front side and the control board 7 of the base 6 at the rear side are accommodated in a casing (not illustrated in FIG. 3). The individual components are electrically connected to the control board 7 through a mechanism (not illustrated), and the record signal input to the head 1 or the reproduction signal generated by the head 1 is processed in the control board 7 through the head amplifier 8.

Next, the control board 7 will be described.

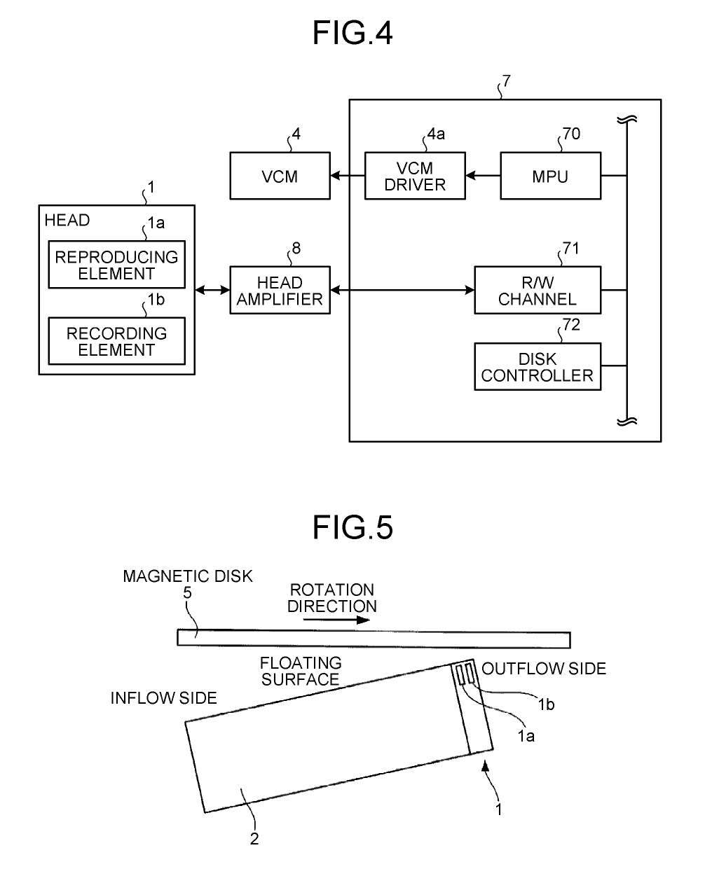

FIG. 4 illustrates the configuration of the control board 7.

In the control board 7, a micro processing unit (MPU) 70 that performs control of the voice coil motor (VCM) 4 through a VCM driver 4a or a disk controller 72 that controls recording/reproducing (access) of the data by the head 1 with respect to the magnetic disk 5 of FIG. 3 is provided. In the control board 7, a read/write (R/W) channel 71 that processes the reproduction signal or the record signal is also provided.

When the data is recorded, the record signal is input from an external apparatus, such as a computer, which is connected to the HDD 10, to the R/W channel 71 through the disk controller 72, and various signal processes, such as an A/D conversion, are executed by the R/W channel 71. The record signal where the signal process is executed is amplified by the head amplifier 8 and input to the recording element 1b in the head 1. As described above, data is recorded in the magnetic disk 5.

When the data is reproduced and the positional information is reproduced, as described above, the reproduction signal is generated by the reproducing element 1a of the head 1. The reproduction signal is amplified by the head amplifier 8 and input to the R/W channel 71, and various signal processes are executed.

In this case, the reproduction signal of the data is transmitted to the disk controller 72 after the signal process in the R/W channel 71, and is transmitted from the disk controller 72 to the external apparatus (computer) connected to the HDD 10.

Meanwhile, the reproduction signal of the positional information is input to the MPU 70 after the signal process in the R/W channel 71. The MPU 70 receives a positioning control execution instruction of the head 1 from the disk controller 72, and controls the VCM 4 through the VCM driver 4a, on the basis of the reproduction signal of the input positional information, thereby performing positioning control of the head 1.

Hereinafter, the head 1 will be described in detail.

FIG. 5 illustrates the head 1 of FIGS. 3 and 4.

In FIG. 5, the head 1, the slider 2, and the magnetic disk 5 are illustrated. If the magnetic disk 5 rotates in the arrow direction of FIG. 5, the slider 2 receives a flow of air flowing from the air inflow side to the air outflow side, from the floating surface, and floats on the magnetic disk 5 (downward direction in FIG. 5). The head 1 is fixed on the front end of the slider 2. By the slider 2 in the floating state, the head 1 is maintained in a state where the floating surface of the head 1 floats at a minute height from the magnetic disk 5. In this case, in the state where the head 1 floats at the minute height from the magnetic disk 5, the reproducing element 1a and the recording element 1b of the head 1 are positioned in a place that is approached to the magnetic disk 5.

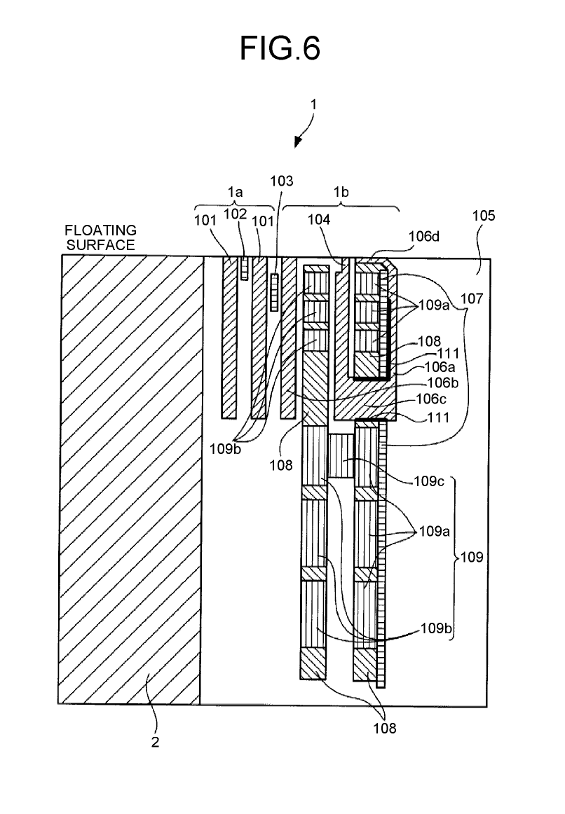

FIG. 6 is a cross-sectional view of the configuration of the head 1 illustrated in FIG. 5.

In FIG. 6, a section of the head 1 in a plane of FIG. 5 is enlarged. In FIG. 6, an upper surface of the head 1 that expands in a horizontal direction (line extending in a horizontal direction) is a floating surface that faces the side of the magnetic disk 5, when the head 1 is approached to the magnetic disk 5 (not illustrated in FIG. 6).

As described above, the head 1 includes the reproducing element 1a and the recording element 1b. The head 1 further includes the heater 103 to adjust a distance from the floating surface of the head 1 to the storage medium. The head 1 has the configuration where the reproducing element 1a, the heater 103, and the recording element 1b are sequentially laminated on the slider 2 through insulating alumina 105 along the floating surface of the head 1.

The reproducing element 1a has the configuration where the magnetoresistive effect film 102 having an electric resistance varying according to the direction of the applied magnetic field is interposed between two magnetic shields 101, and the direction of the magnetization of the storage medium is detected by the magnetoresistive effect film 102.

The recording element 1b includes the double coil 109 functioning as a write coil. The double coil 109 includes two coil portions of the first coil portion 109a and the second coil portion 109b that have different winding directions from each other, but are configured using the same one coil. In FIG. 6, with respect to each of the first coil portion 109a and the second coil portion 109b, 6 coil sections that are arranged in a vertical direction are illustrated. In this case, around the first coil portion 109a and the second coil portion 109b, the insulating resin 108 is filled. The double coil 109 includes the connection coil portion 109c configured using the winding connecting the two coil portions, between the first coil portion 109a and the second coil portion 109b. An inversion of winding directions between the winding direction in the first coil portion 109a and the winding direction in the second coil portion 109b is made by the connection coil portion 109c.

The recording element 1b includes the main magnetic pole 104, the first auxiliary magnetic pole 106a, the second auxiliary magnetic pole 106b, and the connecting portion 106c. Each of the main magnetic pole 104, the first auxiliary magnetic pole 106a, and the second auxiliary magnetic pole 106b extends from the inside of the head 1 to the floating surface, toward the magnetic disk 5 (not illustrated in FIG. 6), and these magnetic poles are arranged along the floating surface. A so-called yoke combines the main magnetic pole 104, the first auxiliary magnetic pole 106a, the second auxiliary magnetic pole 106b, and the connecting portion 106c. A front end of the first auxiliary magnetic pole 106a is provided with the trailing shield 106d that extends in a horizontal direction in FIG. 6. As a material of the main magnetic pole 104, the first auxiliary magnetic pole 106a, the second auxiliary magnetic pole 106b, the connecting portion 106c, and the trailing shield 106d, permalloy that is an alloy (Ni—Fe) of nickel (Ni) and iron (Fe) known as a material having a high magnetic flux density is used. In FIG. 6, only sections of the main magnetic pole 104, the first auxiliary magnetic pole 106a, the second auxiliary magnetic pole 106b, the connecting portion 106c, and the trailing shield 106d of the recording element 1b are illustrated, but the entire shape is the same as that in the conventional double coil. For example, with respect to a vertical direction in FIG. 6, the main magnetic pole 104 has a shape in which a width in the vertical direction is tapered as the main magnetic pole approaches to the floating surface. In the first auxiliary magnetic pole 106a and the second auxiliary magnetic pole 106b, the widths in the vertical direction in FIG. 6 are large as compared with the main magnetic pole 104. The first auxiliary magnetic pole 106a and the second auxiliary magnetic pole 106b have a plate shape. In FIG. 6, a portion corresponding to the thickness of the plate is illustrated. In the recording element 1b of FIG. 6, the main magnetic pole 104 and the first auxiliary magnetic pole 106a are connected to each other by the connecting portion 106c. Meanwhile, the second auxiliary magnetic pole 106b is separated from the main magnetic pole 104 or the connecting portion 106c.

As illustrated in FIG. 6, a winding constituting the first coil portion 109a is provided between the main magnetic pole 104 and the first auxiliary magnetic pole 106a, and the first coil portion 109a winds the connecting portion 106c. If a current flows through the first coil portion 109a, a magnetic flux that passes through the main magnetic pole 104, the connecting portion 106c, and the first auxiliary magnetic pole 106a is generated due to the current.

As illustrated in FIG. 6, a winding constituting the second coil portion 109b is provided between the main magnetic pole 104 and the second auxiliary magnetic pole 106b. As described above, since the first coil portion 109a and the second coil portion 109b are configured using the same one winding, the current that flows through the first coil portion 109a also flows through the second coil portion 109b. Due to the current that flows through the second coil portion 109b, another magnetic flux that passes through the main magnetic pole 104 and the second auxiliary magnetic pole 106b is generated. As described above, since the winding directions of the winding in the first coil portion 109a and the second coil portion 109b are opposite to each other, a magnetic field that is generated due to the current flowing through the first coil portion 109a and the second coil portion 109b becomes a magnetic field that is oriented in the same direction in the main magnetic pole 104. A magnetic field that is obtained by synthesizing the magnetic fields is applied from the main magnetic pole 104 to the storage medium. At this time, magnetization of the same direction as the magnetic field is formed in the storage medium due to the magnetic field applied to the storage medium.

In recent years, in a field of the HDD, it is strongly required to decrease a time needed to store information. Due to this request, in the field of the HDD, a magnetization forming speed is increased by increasing the frequency of the current flowing through the write coil and temporally varying the magnetic field applied from the recording element to the storage medium at a high speed. When the high frequency current flows through the write coil, a large overcurrent is generated on the surface of the magnetic pole due to the high-speed temporal variation of the magnetic field generated in the write coil, and the peripheral portion of the recording element is heated by the Joule heat generated of the generated overcurrent. If the temperature of the peripheral portion of the recording element is increased due to the generated heat, the peripheral portion of the recording element unintentionally protrudes to the surface of the storage medium due to a thermal expansion of a surrounding material of the recording element. In this case, a system (so-called DFH control) where the peripheral portion of the recording element intentionally protrudes to the surface of the storage medium by controlling a heater provided near the recording element is generally known. However, if an unintentional protrusion due to the overcurrent overlaps an intentional protrusion due to the DFH control, the possibility of the peripheral portion of the recording element contacting the surface of the storage medium and the storage medium being damaged increases.

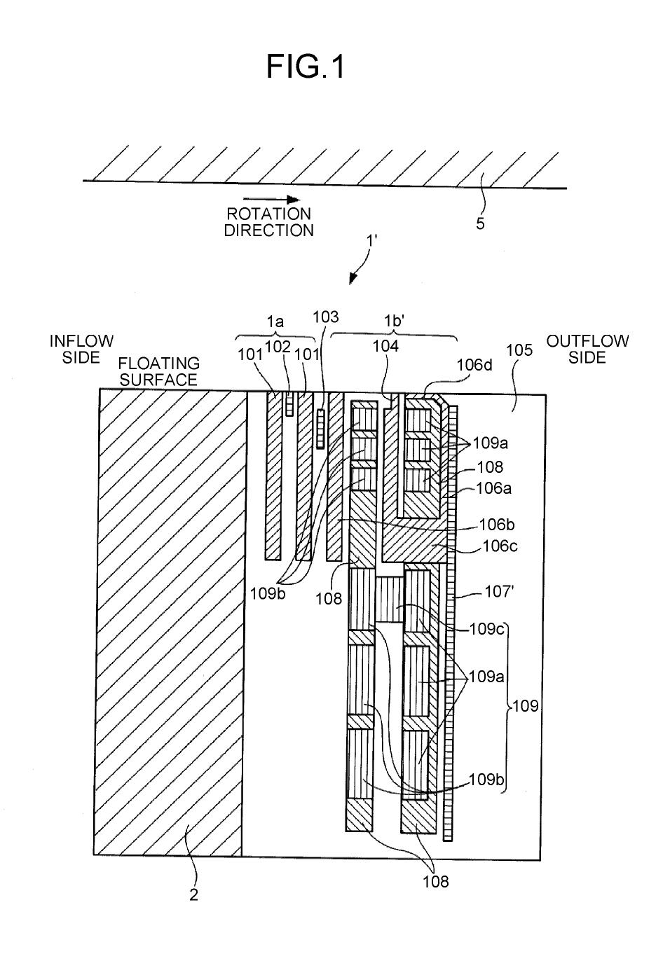

As illustrated in FIG. 1, in the system where the radiating layer is disposed on the outflow end side of the recording element, when a heat power is small, before the peripheral portion of the recording element is heated, it is difficult to transmit the heat to the radiating layer and discharge the heat from the radiating layer. Therefore, the above system is effective. However, when the heat power is large, before the heat is transmitted to the radiating layer and discharged from the radiating layer, the peripheral portion of the recording element may be heated. Therefore, the above system is not effective.

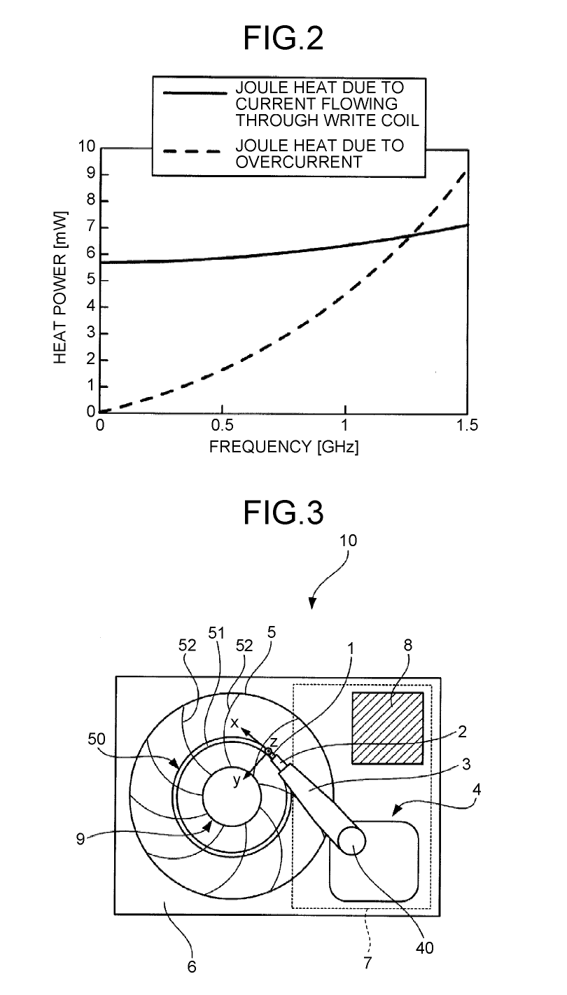

As described above with reference to FIG. 2, if the frequency of the current flowing through the write coil becomes 1.5 GHz or more, the overcurrent increases until an influence due to the overcurrent cannot be ignored. In this embodiment, the HDD 10 is an experimental apparatus devised such that the influence due to the overcurrent is removed. The frequency of 1.5 GHz or more is adopted as the frequency of the current flowing through the double coil 109, such that the devise effect can be apparently recognized. In the HDD 10, in order to discharge the Joule heat of the overcurrent due to the current having the high frequency, the recording element 1b of the head 1 includes a radiating layer 107 that is provided on a surface of the first auxiliary magnetic pole 106a facing the side of the first coil portion 109a or the main magnetic pole 104, that is, a surface of the auxiliary magnetic pole 106a facing the inflow end side of the recording element 1b, and is formed of a material having larger thermal conductivity than the permalloy as the material of the main magnetic pole 104 or the first auxiliary magnetic pole 106a. Specifically, since the thermal conductivity of the permalloy is about 24 W/mK, the radiating layer 107 is formed of a material having thermal conductivity larger than 24 W/mK. FIG. 6 illustrates the radiating layer 107 that is divided into two upper and lower parts by the connecting portion 106c, but this is because FIG. 6 is the cross-sectional view. In actuality, the radiating layer 107 is disposed to expand in a vertical direction in FIG. 6 to surround the connecting portion 106c, and covers the surface of the first auxiliary magnetic pole 106a that faces the side of the first coil portion 109a or the main magnetic pole 104.

In the first auxiliary magnetic pole 106a, since the surface facing the inflow end side of the recording element 1b rather than the surface facing the outflow end side is close to the first coil portion 109a, a strong magnetic field is generated and a large overcurrent flows. However, as illustrated in FIG. 6, if the radiating layer 107 is provided on the surface facing the inflow end side of the recording element 1b, even though the large overcurrent is generated, the Joule heat that is generated due to the overcurrent may be transmitted to the radiating layer 107, and may easily diffuse in a direction (downward direction in FIG. 6) opposite to the floating surface. As a result, in the HDD 10, even though the thermal expansion of the head 1 due to the heat of the overcurrent overlaps the intentional thermal expansion of the head 1 by the DFH control using the heater 103, the head 1 is suppressed from contacting the magnetic disk 5.

In the head 1 of FIG. 6, the largest overcurrent is generated in the first auxiliary magnetic pole 106a, among the main magnetic pole 104, the first auxiliary magnetic pole 106a, and the second auxiliary magnetic pole 106b, which will be described in detail below.

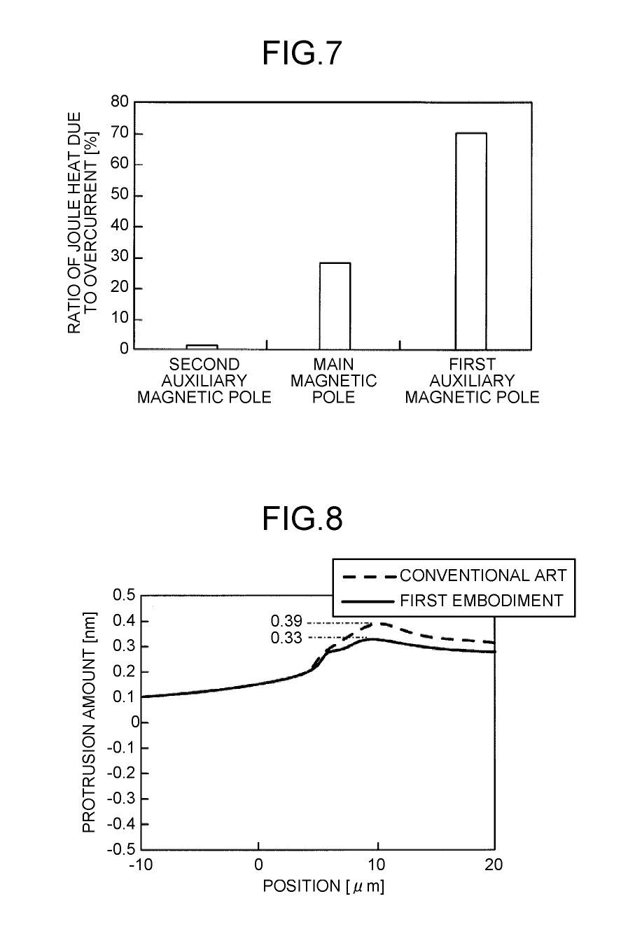

FIG. 7 illustrates the Joule heat for each magnetic pole that is generated due to an overcurrent.

FIG. 7 illustrates a ratio of the Joule heat generated in each of the main magnetic pole 104, the first auxiliary magnetic pole 106a, and the second auxiliary magnetic pole 106b, with respect to the total Joule heat generated due to the overcurrent in the recording element 1b of FIG. 6. As illustrated in FIG. 7, in the head 1 of FIG. 6, the largest overcurrent is generated in the first auxiliary magnetic pole 106a among the three magnetic poles of the main magnetic pole 104, the first auxiliary magnetic pole 106a, and the second auxiliary magnetic pole 106b. The reason for this is as follows. In the head 1 of FIG. 6, the large overcurrent is easily generated near the connecting portion 106c surrounded by the first coil portion 109a, and due to this, the large overcurrent is generated in the first auxiliary magnetic pole 106a where a contact area with the connecting portion 106c is largest.

In FIG. 6, overcurrent generation places 111 where the large overcurrent are generated are indicated by a thick line. In the head 1, among the overcurrent generation places 111, in the overcurrent generation place 111 that exists on the surface facing the inflow end side of the first auxiliary magnetic pole 106a, the radiating layer 107 is disposed. As a result, the heat due to the overcurrent that is generated in the corresponding overcurrent generation place 111 is transmitted to the radiating layer 107, and diffuses in a direction (downward direction in FIG. 6) that is opposite to the floating surface. The overcurrent generation place 111 exists on the surface of the connecting portion 106c, and the radiating layer 107 is not provided in the corresponding overcurrent generation place 111. However, the width of the connecting portion 106c (length of the connecting portion 106c in a horizontal direction of FIG. 6) is sufficiently short, the heat that is generated in the corresponding overcurrent generation place 111 is transmitted to the radiating layer 107 close to the corresponding overcurrent generation place 111 and diffuses, and the heat is suppressed from being accumulated.

In this case, the radiating layer 107 is formed of a material that has a smaller thermal expansion coefficient than the material of the slider 2, and the material of the radiating layer 107 includes at least one of silicon carbide, tungsten, aluminum nitride, and molybdenum.

If the material of the radiating layer 107 has a larger thermal expansion coefficient than the material of the slider 2, the radiating layer 107 receives the heat, and the vicinity of the radiating layer 107 further protrudes to the side of the recording medium, as compared to the floating surface of the slider 2. Accordingly, as the material of the radiating layer 107, a material that has a smaller thermal expansion coefficient than the material of the slider 2 is adopted, thereby suppressing the large protrusion of the vicinity of the radiating layer 107. In particular, the silicon carbide, tungsten, aluminum nitride, and molybdenum are materials that have small thermal expansion coefficients, and a material including at least one of the above materials is adopted, thereby simply realizing suppression of the protrusion.

Next, reduction of the protrusion amount of the head 1 by the radiating layer 107 will be described using a specific simulation result.

In the simulation, in the head 1 using the radiating layer 107 of 1 μm, when it is assumed that the Joule heat due to the overcurrent is generated by 1 mW on the surface of the first auxiliary magnetic pole 106a, the protrusion amount of the slider 2 or the head 1 or an increase in temperature of the recording element 1b near the floating surface are calculated by solving an equation reflecting an electromagnetic characteristic, a thermal conductive characteristic, and a thermal expansion characteristic of the material of the slider 2 or the head 1 using a finite element.

FIG. 8 illustrates a simulation result.

In FIG. 8, a horizontal axis indicates a position (μm) of when a reference position is set as a boundary between the slider 2 and the head 1 of FIG. 6 with respect to a direction along the floating surface of FIG. 6 and a rightward direction of FIG. 6 (direction toward the side of the head 1) is set as a positive direction, and a vertical axis indicates the protrusion amount (unit is μm). That is, a position where the coordinates of the horizontal axis becomes 0 μm is the position of the boundary between the slider 2 and the head 1 of FIG. 6.

In FIG. 8, under the coordinates, the variation in the protrusion amount of the slider 2 or the head 1 of FIG. 6 along the floating surface at the time of recording information is illustrated by a solid line graph. Here, at the vicinity where the coordinates of the horizontal axis are 10 μm, the recording element 1b of FIG. 6 is provided. As illustrated in FIG. 8, the protrusion amount at the vicinity is large, and a maximum value of the protrusion amount is 0.33 nm. The temperature of the recording element 1b near the floating surface increases by 1.25° C., as compared with the case of when the information is not recorded.

In the simulation, for a comparison, with respect to the conventional head 1′ of FIG. 1 where the radiating layer 107′ exists on the surface of the first auxiliary magnetic pole 106a opposite to the side of the first coil portion 109a, the protrusion amount or the increase in the temperature of the recording element 1b near the floating surface is calculated. The conventional head 1′ has the same configuration as the head 1 of FIG. 6, except for the provision position of the radiating layer. In FIG. 8, the protrusion amount with respect to the conventional head 1′ is illustrated by a dotted line, and the maximum value of the protrusion amount is 0.39 nm. In the conventional head 1′, the temperature of the recording element 1b near the floating surface is increased by 1.65° C., as compared with the case of when the information is not recorded.

If the simulation result with respect to the head 1 of FIG. 6 and the simulation result with respect to the conventional head 1′ of FIG. 1 are compared with each other, in regards to the maximum protrusion amount, the maximum protrusion amount of the head 1 of FIG. 6 has 0.33 nm that is 0.06 nm smaller than 0.39 nm that is the maximum protrusion amount of the conventional head 1′ of FIG. 1. With regard to the increase in the temperature, the increase in the temperature in the head 1 of FIG. 6 is 1.25° C. that is 0.4° C. lower than 1.65° C. that is the increase in the temperature of the conventional head 1′ of FIG. 1. Accordingly, if the result of the conventional head 1′ is used as a reference, in the head 1 of FIG. 6, with regard to the maximum protrusion amount, a reduction effect of 0.06 nm/0.39 nm=15.4% is obtained. With regard to the increase in the temperature, a reduction effect of 0.4° C./1.65° C.=24.2% is obtained.

In conclusion, if the radiating layer 107 exists on the surface of the first auxiliary magnetic pole 106a at the side of the first coil portion 109a as in the head 1 of FIG. 6, the heat that is generated in the first auxiliary magnetic pole 106a efficiently diffuses.

Next, a second embodiment will be described.

A magnetic head according to the second embodiment is also a head slider that includes a head and a slider, and an information storage apparatus according to the second embodiment is an HDD that includes the head slider. The head slider and the HDD according to the second embodiment are different from the head slider according to the first embodiment (that is, combination of the head 1 and the slider 2 of FIG. 6) and the HDD 10 of FIG. 3 in the configuration of the recording element in the head. With regard to the other configuration, the head slider and the HDD according to the second embodiment are the same as the head slider according to the first embodiment (that is, combination of the head 1 and the slider 2 of FIG. 6) and the HDD 10 of FIG. 3. Accordingly, the configuration of the recording element that is the difference between the first and second embodiments will be mainly described.

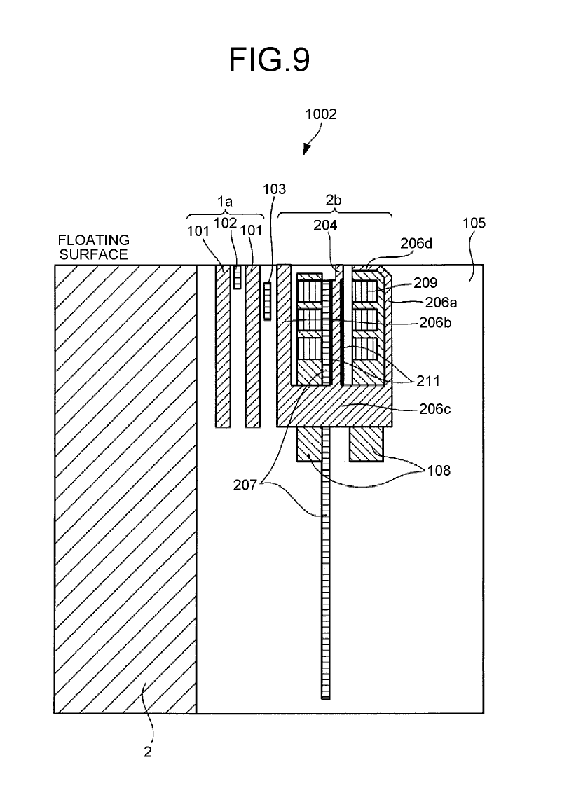

FIG. 9 is a cross-sectional view of the configuration of a head 1002 in the head slider according to the second embodiment.

In FIG. 9, the same components as that of the head 1 and the slider 2 of FIG. 6 are denoted by the same reference numerals and the description of the same components is omitted. In FIG. 9, an upper surface of the head 1002 expanding in a horizontal direction (line extending in the horizontal direction) is a floating surface toward the side of the magnetic disk, when the head 1002 approaches to the magnetic disk (not illustrated in FIG. 9).

A recording element 2b of the head 1002 of FIG. 9 includes a helical coil 209 that functions as a write coil, and the helical coil 209 is a coil that is composed of a spirally wound winding, as described in detail below.

The recording element 2b of FIG. 9 includes a main magnetic pole 204, a first auxiliary magnetic pole 206a, a second auxiliary magnetic pole 206b, and a connecting portion 206c. Each of the main magnetic pole 204, the first auxiliary magnetic pole 206a, and the second auxiliary magnetic pole 206b extends from the inside of the head 1002 to the floating surface, toward the magnetic disk (not illustrated in FIG. 6), and these magnetic poles are arranged along the floating surface. A so-called yoke combines the main magnetic pole 204, the first auxiliary magnetic pole 206a, the second auxiliary magnetic pole 206b, and the connecting portion 206c. A front end of the first auxiliary magnetic pole 206a is provided with a trailing shield 206d that extends in a horizontal direction in FIG. 9. As a material of the main magnetic pole 204, the first auxiliary magnetic pole 206a, the second auxiliary magnetic pole 206b, the connecting portion 206c, and the trailing shield 206d, permalloy that is an alloy (Ni—Fe) of nickel (Ni) and iron (Fe) known as a material having a high magnetic flux density is used. In FIG. 9, only sections of the main magnetic pole 204, the first auxiliary magnetic pole 206a, the second auxiliary magnetic pole 206b, the connecting portion 206c, and the trailing shield 206d of the recording element 2b are illustrated, but the entire shape is the same as that in the conventional helical coil (for example, helical coil disclosed in Japanese Patent Application Publication (KOKAI) No. 2006-244692). For example, with respect to a vertical direction in FIG. 9, the main magnetic pole 204 has a shape in which a width in the vertical direction is tapered as the main magnetic pole approaches to the floating surface. In the first auxiliary magnetic pole 206a and the second auxiliary magnetic pole 206b, the widths in the vertical direction in FIG. 9 are large as compared with the main magnetic pole 204. The first auxiliary magnetic pole 206a and the second auxiliary magnetic pole 206b have a plate shape. In FIG. 9, a portion corresponding to the thickness of the plate is illustrated. In the recording element 2b of FIG. 9, the main magnetic pole 204 is connected to both the first auxiliary magnetic pole 206a and the second auxiliary magnetic pole 206b by the connecting portion 206c.

The main magnetic pole 204 is linked with the helical coil 209. In FIG. 9, with respect to the helical coil 209, coil sections of two columns each including three coil sections arranged in a vertical direction are illustrated. The winding that constitutes the helical coil 209 spirally winds the main magnetic pole 204 in the order of the first coil section from the upper side of the right column→the first coil section from the upper side of the left column→the second coil section from the upper side of the right column→the second coil section from the upper side of the left column→the third coil section from the upper side of the right column→the third coil section from the upper side of the left column. As such, if the winding winds the main magnetic pole 204, in the recording element 2b of FIG. 9, the configuration where the winding constituting the helical coil 209 exists between the main magnetic pole 204 and the first auxiliary magnetic pole 206a and between the main magnetic pole 204 and the second auxiliary magnetic pole 206b is realized.

In this case, if a current flows through the helical coil 209, a magnetic flux that passes through the main magnetic pole 204 is generated due to the current. At this time, magnetization of the same direction as a direction of the magnetic field is formed in the storage medium, due to the magnetic field that is applied from the front end of the main magnetic pole 204 facing the upper side of FIG. 9 to the storage medium. In this case, a portion of the magnetic flux that passes through the main magnetic pole 204 passes through a portion of the connecting portion 206c existing at the right side of FIG. 9 more than a connection place with the main magnetic pole 204 and the first auxiliary magnetic pole 206a, is returned to the main magnetic pole 204, and goes around. Further, another portion of the magnetic flux that passes through the main magnetic pole 204 passes through a portion of the connecting portion 206c existing at the left side of FIG. 9 more than the connection place with the main magnetic pole 204 and the second auxiliary magnetic pole 206b, and goes around.

Similar to the first embodiment, even in the second embodiment, as a current flowing through the recording element 2b, a current having a high frequency of 1.5 GHz or more is used. In the HDD, in order to discharge the Joule heat of the overcurrent due to the current having the high frequency, the recording element 2b of the head 1002 includes a radiating layer 207 that is provided on the surface of the main magnetic pole 204 that faces the side of the second auxiliary magnetic pole 206b. The radiating layer 207 is formed of a material having larger thermal conductivity than the permalloy as the material of the main magnetic pole 204, the first auxiliary magnetic pole 206a or the second auxiliary magnetic pole 206b. In general, since the thermal conductivity of the permalloy is about 24 W/mK, the radiating layer 207 is formed of a material having thermal conductivity larger than 24 W/mK. FIG. 9 illustrates the radiating layer 207 that is divided into two upper and lower parts by the connecting portion 206c, but this is because FIG. 9 is the cross-sectional view. In actuality, the radiating layer 207 is disposed to expand in a vertical direction in FIG. 9 to surround the connecting portion 206c, and a portion of the radiating layer 207 covers the surface of the main magnetic pole 204 that faces the side of the second auxiliary magnetic pole 206b.

If the radiating layer exists on the surface of the first auxiliary magnetic pole 206a or the second auxiliary magnetic pole 206b at the outflow end side (surface opposite to the surface facing the winding of the helical coil 209), and not on the surface of the main magnetic pole 204, before the Joule heat generated due to the overcurrent on the surface of the main magnetic pole 204 is transmitted to the radiating layer and diffuses, the peripheral portion of the main magnetic pole 204 maybe thermally expanded due to the Joule heat, and the head may contact the magnetic disk.

In the head 1002 illustrated in FIG. 9, on at least one surface among the surfaces of the main magnetic pole 204, for example, on the surface of the main magnetic pole 204 facing the side of the second auxiliary magnetic pole 206b, the radiating layer 207 is provided. For this reason, even though the large overcurrent is generated on the surface of the main magnetic pole 204, the Joule heat that is generated due to the overcurrent is transmitted to the radiating layer 207 and is likely to diffuse in a direction (downward direction in FIG. 9) opposite to the floating surface. As a result, in the head 1002 that is illustrated in FIG. 9, the head 1002 is suppressed from contacting the magnetic disk 5, because of the thermal expansion of the head 1002 by the heat generated due to the overcurrent.

In the head 1002 of FIG. 9, the largest overcurrent is generated in the main magnetic pole 204, among the main magnetic pole 204, the first auxiliary magnetic pole 206a, and the second auxiliary magnetic pole 206b, which will be described in detail below.

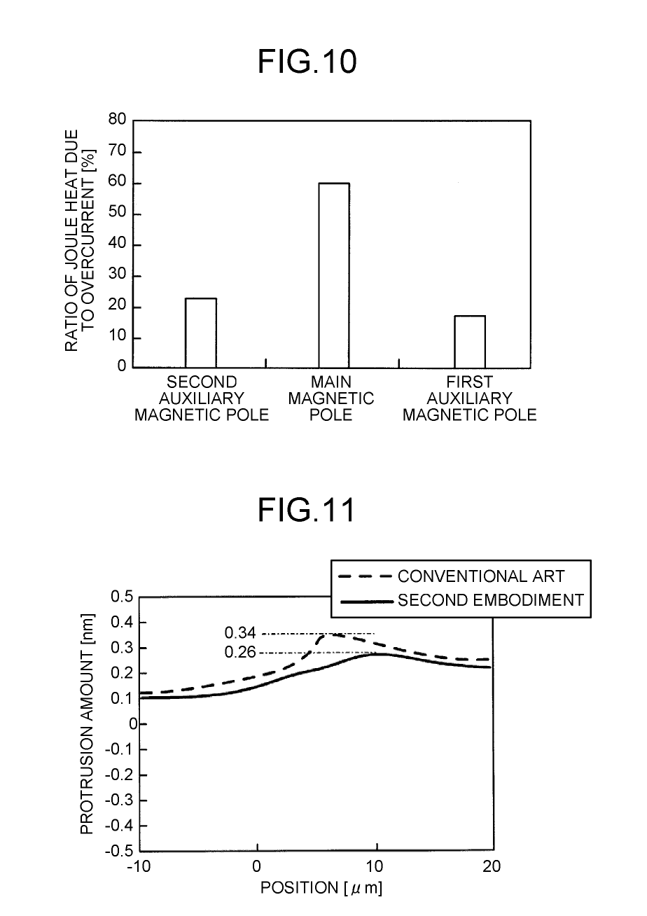

FIG. 10 illustrates the Joule heat for each magnetic pole that is generated due to an overcurrent.

FIG. 10 illustrates a ratio of the Joule heat generated in each of the main magnetic pole 204, the first auxiliary magnetic pole 206a, and the second auxiliary magnetic pole 206b, with respect to the total Joule heat generated due to the overcurrent in the recording element 2b of FIG. 9. As illustrated in FIG. 10, in the head 1002 of FIG. 9, the largest overcurrent is generated in the main magnetic pole 204 among the three magnetic poles of the main magnetic pole 204, the first auxiliary magnetic pole 206a, and the second auxiliary magnetic pole 206b. The reason for this is as follows. In the head 1002 of FIG. 9, the large magnetic flux is generated near the main magnetic pole 204 surrounded by the helical coil 209, and due to this, the large overcurrent is generated.

In FIG. 9, overcurrent generation places 211 where the large overcurrent are generated are indicated by a thick line. The overcurrent generation places 211 exist on the surface of the main magnetic pole 204. If the radiating layer 207 is provided on at least one surface among the surfaces of the main magnetic pole 204, for example, the surface of the main magnetic pole 204 facing the side of the second auxiliary magnetic pole 206b, the Joule heat that is generated due to the overcurrent is transmitted to the radiating layer 207 and diffuses in a direction (downward direction in FIG. 9) opposite to the floating surface. In addition to the surface of the main magnetic pole 204 facing the side of the second auxiliary magnetic pole 206b among the surfaces of the main magnetic pole 204, on the surface of the main magnetic pole 204 facing the first auxiliary magnetic pole 206a, the Joule heat is generated due to the overcurrent. However, since the radiating layer 207 exists near the surface of the main magnetic pole 204 facing the side of the first auxiliary magnetic pole 206a, the Joule heat that is generated on the surface facing the side of the first auxiliary magnetic pole 206a is transmitted to the radiating layer 207 and diffuses in a direction (downward direction in FIG. 9) opposite to the floating surface.

In this case, the radiating layer 207 is formed of a material that has a smaller thermal expansion coefficient than the material of the slider 2, and the material of the radiating layer 207 includes at least one of silicon carbide, tungsten, aluminum nitride, and molybdenum.

Similar to the first embodiment, even in the second embodiment, if the material of the radiating layer 207 has a larger thermal expansion coefficient than the material of the slider 2, the radiating layer 107 receives the heat, and the large protrusion of the vicinity of the radiating layer 207 is suppressed. In particular, by using the material including at least one of the silicon carbide, tungsten, aluminum nitride, and molybdenum, suppression of the protrusion can be simply realized.

Next, reduction of the protrusion amount of the head 1002 by the radiating layer 207 will be described using a specific simulation result.

In the simulation, in the head 1002 using the radiating layer 207 of 1 μm, when it is assumed that the Joule heat due to the overcurrent is generated by 1 mW on the surface of the main magnetic pole 204, the protrusion amount of the slider 2 or the head 1002 or an increase in temperature of the recording element 2b near the floating surface are calculated by solving an equation reflecting an electromagnetic characteristic, a thermal conductive characteristic, and a thermal expansion characteristic of the material of the slider 2 or the head 1002 using a finite element.

FIG. 11 illustrates a simulation result.

In FIG. 11, a horizontal axis indicates a position (unit is μm) of when a reference position is set as a boundary between the slider 2 and the head 1002 of FIG. 9 with respect to a direction along the floating surface of FIG. 9 and a rightward direction of FIG. 9 (direction toward the side of the head 1002) is set as a positive direction, and a vertical axis indicates the protrusion amount (unit is nm). That is, a position where the coordinates of the horizontal axis becomes 0 μm is the position of the boundary between the slider 2 and the head 1002 of FIG. 9.

In FIG. 11, under the coordinates, the variation in the protrusion amount of the slider 2 or the head 1002 of FIG. 9 along the floating surface at the time of recording information is displayed by a solid line graph. Here, at the vicinity where the coordinates of the horizontal axis are 9 μm, the recording element 2b of FIG. 9 is provided. As illustrated in FIG. 11, the protrusion amount at the vicinity is large, and a maximum value of the protrusion amount is 0.26 nm. The temperature of the recording element 2b near the floating surface increases by 1.23° C., as compared with the case of when the information is not recorded.

In the simulation, for a comparison, with respect to the conventional head of the helical coil system where the radiating layer exists on the surface of the first auxiliary magnetic pole 206a at the side of the outflow end (surface opposite to the surface facing the winding of the helical coil 209), the protrusion amount or the increase in the temperature of the recording element 2b near the floating surface is calculated. The conventional head of the helical coil system has the same configuration as the head 1002 of FIG. 9, except for the provision position of the radiating layer. In FIG. 11, the protrusion amount with respect to the conventional head of the helical coil system is illustrated by a dotted line, and the maximum value of the protrusion amount is 0.34 nm. In the conventional head of the helical coil system, the temperature of the recording element near the floating surface is increased by 2.03° C., as compared with the case of when the information is not recorded.

If the simulation result with respect to the head 1002 of FIG. 9 and the simulation result with respect to the conventional head of the helical coil system are compared with each other, in regards to the maximum protrusion amount, the maximum protrusion amount of the head 1002 of FIG. 9 has 0.26 nm that is 0.08 nm smaller than 0.34 nm that is the maximum protrusion amount of the conventional head of the helical coil system. In regards to the increase in the temperature, the increase in the temperature in the head 1002 of FIG. 9 is 1.23° C. that is 0.8° C. lower than 2.03° C. that is the increase in the temperature of the conventional head of the helical coil system. Accordingly, if the result of the conventional head of the helical coil system is used as a reference, in the head 1002 of FIG. 9, in regards to the maximum protrusion amount, a reduction effect of 0.08 nm/0.34 nm=23.5% is obtained. In regards to the increase in the temperature, a reduction effect of 0.8° C./2.03° C.=39.4% is obtained.

In conclusion, if the radiating layer 207 exists on the surface of the main magnetic pole 204 as in the head 1002 of FIG. 9, the heat that is generated in the first auxiliary magnetic pole 206a efficiently diffuses.

Next, a third embodiment will be described.

A magnetic head according to the third embodiment is also a head slider that includes a head and a slider, and an information storage apparatus according to the third embodiment is an HDD that includes the head slider. The head slider and the HDD according to the third embodiment are different from the head slider according to the first embodiment (that is, combination of the head 1 and the slider 2 of FIG. 6) and the HDD 10 of FIG. 3 in the configuration of the recording element in the head. With regard to the other configuration, the head slider and the HDD according to the third embodiment are the same as the head slider according to the first embodiment (that is, combination of the head 1 and the slider 2 of FIG. 6) and the HDD 10 of FIG. 3. Accordingly, the configuration of the recording element that is the difference between the first and third embodiments will be mainly described.

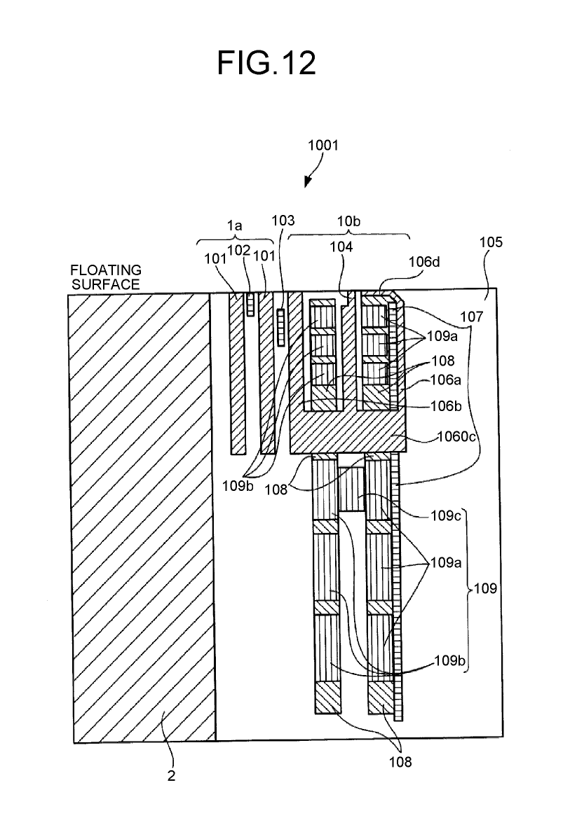

FIG. 12 is a cross-sectional view of the configuration of a head 1001 in the head slider according to the third embodiment.

In FIG. 12, the same components as the components of the head 1 and the slider 2 of FIG. 6 are denoted by the same reference numerals and the description of the same components is omitted. A recording element 10b in the head 1001 of FIG. 12 is different from the recording element 1b in the head 1 of FIG. 6 in that the second auxiliary magnetic pole 106b is connected to the main magnetic pole 104 or the first auxiliary magnetic pole 106a by a connecting portion 1060c in the recording element 10b of FIG. 12. With regard to the other configuration, the recording element 10b of FIG. 12 has the same configuration as that in the recording element 1b of FIG. 6. Accordingly, even in the recording element 10b of FIG. 12, the radiating layer 107 is provided on the surface of the first auxiliary magnetic pole 106a facing the inflow end side of the first coil portion 109a or the main magnetic pole 104, that is, the surface of the first auxiliary magnetic pole 106a facing the inflow end side of the recording element 1b. As described above, the radiating layer 107 is formed of a material having larger thermal conductivity than the permalloy as the material of the main magnetic pole 104 or the first auxiliary magnetic pole 106a.

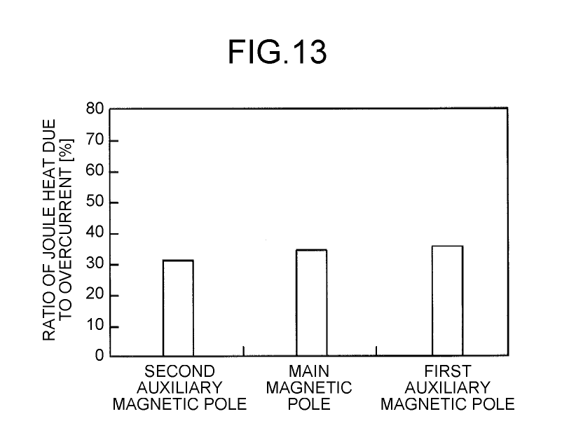

FIG. 13 illustrates the Joule heat for each magnetic pole that is generated due to an overcurrent of the recording element 10b of FIG. 12.

FIG. 13 illustrates a ratio of the Joule heat generated in each of the main magnetic pole 104, the first auxiliary magnetic pole 106a, and the second auxiliary magnetic pole 106b, with respect to the total Joule heat generated due to the overcurrent in the recording element 10b of FIG. 12. As illustrated in FIG. 13, the Joule heat that is generated in each magnetic pole has a similar value, but the slightly strong Joule heat is generated in the first auxiliary magnetic pole 106a, as compared with the main magnetic pole 104 or the second auxiliary magnetic pole 106b. Different from FIG. 7, in FIG. 13, the Joule heat that is generated in the first auxiliary magnetic pole 106a and the Joule heat that is generated in the second auxiliary magnetic pole 106b have values similar to each other. This is because the second auxiliary magnetic pole 106b is connected to the main magnetic pole 104 by the connecting portion 1060c, similar to the first auxiliary magnetic pole 106a, in the recording element 10b of FIG. 12. However, since the trailing shield 206d exists on the front end of the first auxiliary magnetic pole 106a, the magnetic flux that passes through the first auxiliary magnetic pole 106a is slightly stronger than the magnetic flux that passes through the second auxiliary magnetic pole 106b. For this reason, as illustrated in FIG. 12, a heat power of the Joule heat that is generated in the first auxiliary magnetic pole 106a is slightly larger than a heat power of the Joule heat that is generated in the second auxiliary magnetic pole 106b.

Even in the head 1001 illustrated in FIG. 12, on the surface of the first auxiliary magnetic pole 106a (where the strongest Joule heat is generated) facing the side of the first coil portion 109a or the main magnetic pole 104, the radiating layer 107 is provided. For this reason, the Joule heat that is generated due to the overcurrent on the surface of the first auxiliary magnetic pole 106a is transmitted to the radiating layer 107 and is likely to diffuse in a direction (downward direction in FIG. 12) opposite to the floating surface. As a result, even in the head 1001 of FIG. 12, the head is suppressed from contacting the magnetic disk, because of the thermal expansion of the head due to the overcurrent.

Next, a fourth embodiment will be described.

A magnetic head according to the fourth embodiment is also a head slider that includes a head and a slider, and an information storage apparatus according to the fourth embodiment is an HDD that includes the head slider. The head slider and the HDD according to the fourth embodiment are different from the head slider according to the first embodiment (that is, combination of the head 1 and the slider 2 of FIG. 6) and the HDD 10 of FIG. 3 in that the head according to the fourth embodiment has radiating layers of the number larger than the number of radiating layers of the head 1 of FIG. 6. With regard to the other configuration, the head slider and the HDD according to the fourth embodiment are the same as the head slider according to the first embodiment (that is, combination of the head 1 and the slider 2 of FIG. 6) and the HDD 10 of FIG. 3. Accordingly, the configuration of the recording element that is the difference between the first and fourth embodiments will be mainly described.

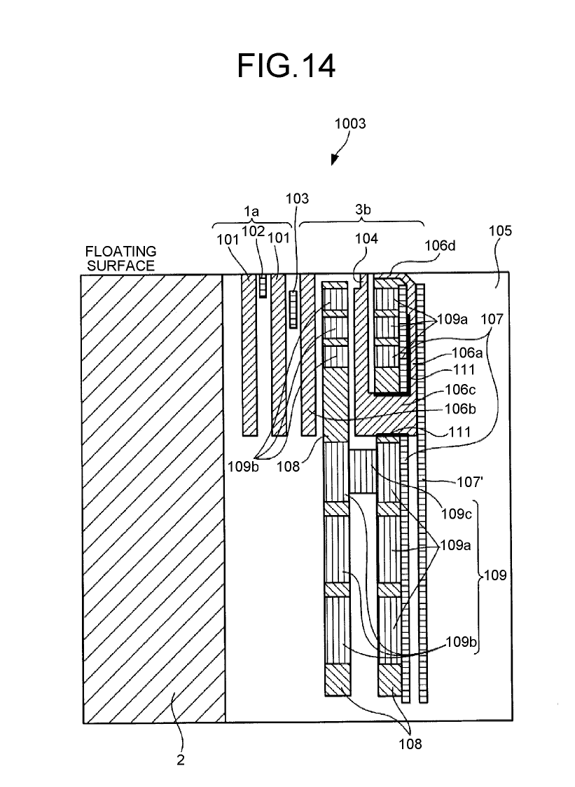

FIG. 14 is a cross-sectional view of the configuration of a head 1003 in the head slider according to the fourth embodiment.

In FIG. 14, the same components as the components of the head 1 and the slider 2 of FIG. 6 are denoted by the same reference numerals and the description of the same components is omitted. The head 1003 of FIG. 14 is different from the head 1 of FIG. 6 in that a radiating layer is also provided on one side of the first auxiliary magnetic pole 106a facing a direction opposite to a direction to which other surface of the first auxiliary magnetic pole 106a facing the first coil portion 109a is facing. That is, in the head 1003 of FIG. 14, a recording element 3b includes the radiating layer 107 that is provided on one surface of the first auxiliary magnetic pole 106a facing the side of the first coil portion 109a or the main magnetic pole 104, and a second radiating layer 107′ that is provided on other surface of the first auxiliary magnetic pole 106a opposite to the corresponding surface. In this case, the second radiating layer 107′ is formed of the same material as the radiating layer 107 that is provided on the surface of the first auxiliary magnetic pole 106a facing the side of the first coil portion 109a or the main magnetic pole 104.

In the head 1003 of FIG. 14, since the two radiating layers are provided, an effect of diffusing the Joule heat due to the overcurrent on the surface of the first auxiliary magnetic pole 106a in a direction (downward direction in FIG. 14) opposite to the floating surface is improved.

Next, a fifth embodiment will be described.

A magnetic head according to the fifth embodiment is also a head slider that includes a head and a slider, and an information storage apparatus according to the fifth embodiment is an HDD that includes the head slider. The head slider and the HDD according to the fifth embodiment are different from the head slider according to the second embodiment (that is, combination of the head 1002 and the slider 2 of FIG. 9) and the HDD according to the second embodiment (that is, HDD using the head slider according to the second embodiment and equal to the HDD 10 according to the first embodiment, except for the head slider) in that the head according to the fifth embodiment has radiating layers of the number larger than the number of radiating layers of the head 1002 of FIG. 9. With regard to the other configuration, the head slider and the HDD according to the fifth embodiment are the same as the head slider and the HDD according to the second embodiment. Accordingly, the configuration of the recording element that is the difference between the first and fifth embodiments will be mainly described.

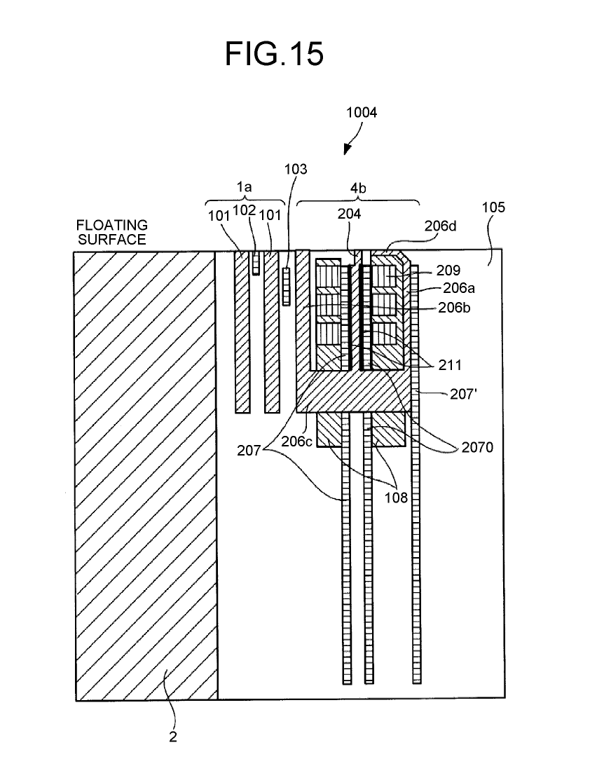

FIG. 15 is a cross-sectional view of the configuration of a head 1004 in the head slider according to the fifth embodiment.

In FIG. 15, the same components as the components of the head 1002 and the slider 2 of FIG. 9 are denoted by the same reference numerals and the description of the same components is omitted. The head 1004 of FIG. 15 is different from the head 1002 of FIG. 9 in that the radiating layers are provided on the surface of the main magnetic pole 204 facing the side of the first auxiliary magnetic pole 206a and the surface opposite to the surface of the first auxiliary magnetic pole 206a facing the side of the main magnetic pole 204, in the head 1004 of FIG. 15. That is, in the head 1004 of FIG. 15, a recording element 4b includes the radiating layer 207 that is provided on the surface of the main magnetic pole 204 facing the side of the second auxiliary magnetic pole 206b, another radiating layer 2070 that is provided on a surface of the main magnetic pole 104 opposite to the corresponding surface, and the other radiating layer 207′ that is provided on the surface of the first auxiliary magnetic pole 206a opposite to the surface of the first auxiliary magnetic pole 206a facing the side of the main magnetic pole 204. In this case, the two radiating layers 2070 and 207′ are formed of the same material as the radiating layer 207 that is provided on the surface of the main magnetic pole 204 facing the side of the second auxiliary magnetic pole 206b.

In the head 1004 of FIG. 15, since the three radiating layers are provided, the Joule heat due to the overcurrent on the surface of the main magnetic pole 204 and the Joule heat due to the overcurrent on the surface of the first auxiliary magnetic pole 106a can be efficiently diffused in a direction (downward direction in FIG. 14) opposite to the floating surface.

Next, a sixth embodiment will be described.

A magnetic head according to the sixth embodiment is also a head slider that includes a head and a slider, and an information storage apparatus according to the sixth embodiment is an HDD that includes the head slider. The head slider and the HDD according to the sixth embodiment are different from the head slider according to the fifth embodiment (that is, combination of the head 1004 and the slider 2 of FIG. 15) and the HDD according to the fifth embodiment (that is, HDD using the head slider according to the fifth embodiment and equal to the HDD 10 according to the first embodiment, except for the head slider) in that the head according to the sixth embodiment has radiating layers of the number, which is larger than the number of radiating layers of the head 1004 of FIG. 15 by 1. With regard to the other configuration, the head slider and the HDD according to the sixth embodiment are the same as the head slider and the HDD according to the fifth embodiment. Accordingly, the configuration of the recording element that is the difference between the fifth and sixth embodiments will be mainly described.

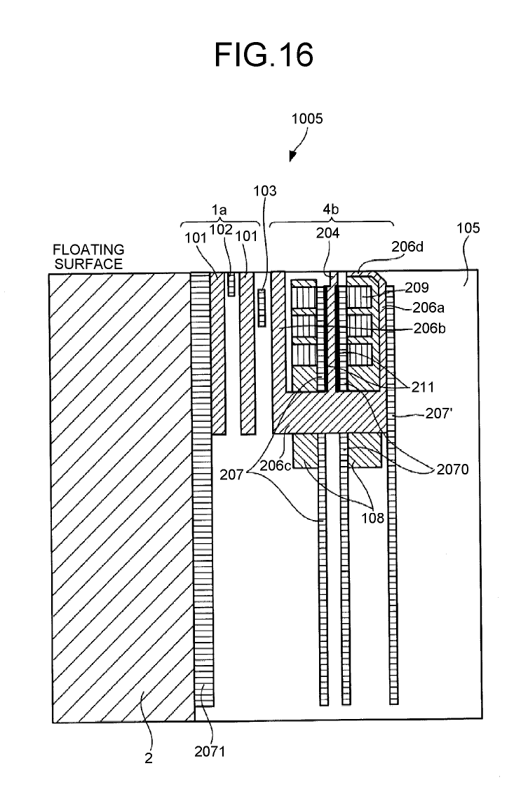

FIG. 16 is a cross-sectional view of the configuration of a head 1005 in the head slider according to the sixth embodiment.

In FIG. 16, the same components as the components of the head 1004 and the slider 2 of FIG. 15 are denoted by the same reference numerals and the description of the same components is omitted. The head 1005 of FIG. 16 is different from the head 1004 of FIG. 15 in that a radiating layer is provided between the head 1005 and the slider 2, in the head 1005 of FIG. 16. That is, in the head 1005 of FIG. 16, the recording element 4b includes the radiating layers 207 and 2070 that are provided on both surfaces of the main magnetic pole 204, another radiating layer 207′ that is provided on a surface of the first auxiliary magnetic pole 206a opposite to the surface of the first auxiliary magnetic pole 206a facing the side of the main magnetic pole 204, and the other radiating layer 2071 that is provided between the head 1005 and the slider 2. In this case, the new radiating layer 2071 is formed of the same material as the radiating layers 207 and 2070 that are provided on both surfaces of the main magnetic pole 204 and the radiating layer 207′ that is provided on the surface opposite to the surface of the first auxiliary magnetic pole 206a facing the side of the main magnetic pole 104.

In the head 1005 of FIG. 16, since the radiating layer 2071 is provided between the head 1005 and the slider 2, before the heat is transmitted to the slider 2, the heat is likely to diffuse in a direction (downward direction in FIG. 16) opposite to the floating surface by the radiating layer 2071, and the thermal expansion of the slider 2 is suppressed.

Next, a seventh embodiment will be described.

A magnetic head according to the seventh embodiment is also a head slider that includes a head and a slider, and an information storage apparatus according to the seventh embodiment is an HDD that includes the head slider. The head slider and the HDD according to the seventh embodiment are different from the head slider according to the fifth embodiment (that is, combination of the head 1004 and the slider 2 of FIG. 15) and the HDD according to the fifth embodiment (that is, HDD using the head slider according to the fifth embodiment and equal to the HDD 10 according to the first embodiment, except for the head slider) in that the head according to the seventh embodiment has radiating layers of the number, which is larger than the number of radiating layers of the head 1004 of FIG. 15 by 1. With regard to the other configuration, the head slider and the HDD according to the seventh embodiment are the same as the head slider and the HDD according to the fifth embodiment. Accordingly, the configuration of the recording element that is the difference between the fifth and seventh embodiments will be mainly described.

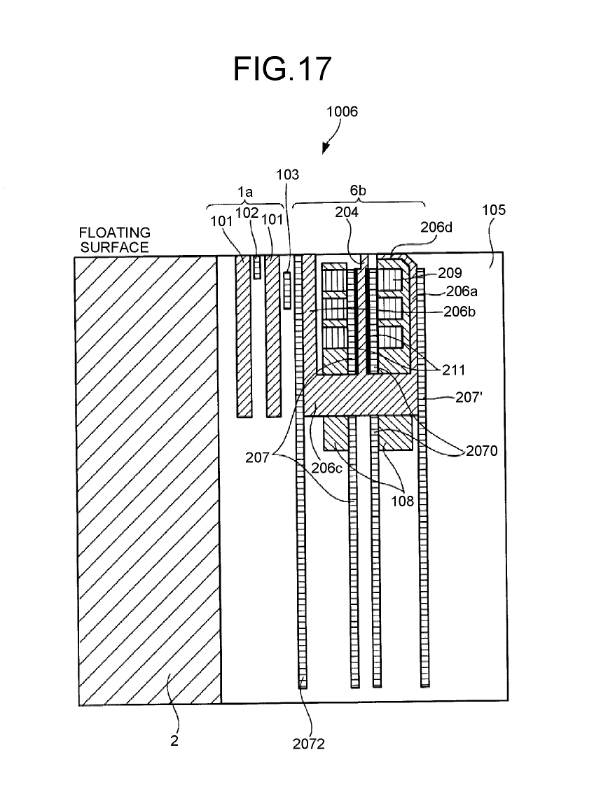

FIG. 17 is a cross-sectional view of the configuration of a head 1006 in the head slider according to the seventh embodiment.

In FIG. 17, the same components as the components of the head 1004 and the slider 2 of FIG. 15 are denoted by the same reference numerals and the description of the same components is omitted. The head 1006 of FIG. 17 is different from the head 1004 of FIG. 15 in that a radiating layer is provided on the surface of the second auxiliary magnetic pole 206b, in the head 1006 of FIG. 17. That is, in the head 1006 of FIG. 17, a recording element 6b includes the radiating layers 207 and 2070 that are provided on both surfaces of the main magnetic pole 204, another radiating layer 207′ that is provided on a surface of the first auxiliary magnetic pole 206a opposite to the surface of the first auxiliary magnetic pole 206a facing the side of the main magnetic pole 104, and the other radiating layer 2072 that is provided on the surface of the second auxiliary magnetic pole 206b facing the side of the slider 2. In this case, the radiating layer 2072 is formed of the same material as the radiating layers 207 and 2070 that are provided on both surfaces of the main magnetic pole 204 and the radiating layer 207′ that is provided on the surface opposite to the surface of the first auxiliary magnetic pole 206a facing the side of the main magnetic pole 104.

In the head 1006 of FIG. 17, since the radiating layer 2072 is provided on the surface of the second auxiliary magnetic pole 206b facing the side of the slider 2, before the heat is transmitted to the reproducing element 1a or the slider 2, the heat is likely to diffuse in a direction (downward direction in FIG. 17) opposite to the floating surface by the radiating layer 2072, and the thermal expansion of the peripheral portion of the reproducing element 1a or the slider 2 is suppressed.

Next, an eighth embodiment will be described.

A magnetic head according to the eighth embodiment is also a head slider that includes a head and a slider, and an information storage apparatus according to the eighth embodiment is an HDD that includes the head slider. The head slider and the HDD according to the eighth embodiment are different from the head slider according to the fifth embodiment (that is, combination of the head 1004 and the slider 2 of FIG. 15) and the HDD according to the fifth embodiment (that is, HDD using the head slider according to the fifth embodiment and equal to the HDD 10 according to the first embodiment, except for the head slider) in that the head according to the eighth embodiment has two radiating layers, which are smaller than radiating layers of the head 1004 of FIG. 15 by 1, but has a heat transmitting member interposed between the two radiating layers and the slider 2. With regard to the other configuration, the head slider and the HDD according to the eighth embodiment are the same as the head slider and the HDD according to the fifth embodiment. Accordingly, the configuration of the recording element that is the difference between the fifth and eighth embodiments will be mainly described.

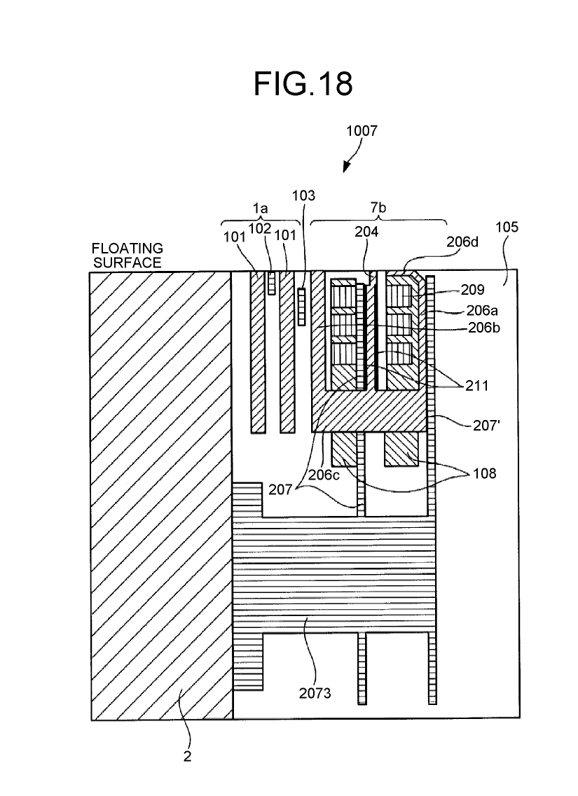

FIG. 18 is a cross-sectional view of the configuration of a head 1007 in the head slider according to the eighth embodiment.

In FIG. 18, the same components as the components of the head 1004 and the slider 2 of FIG. 15 are denoted by the same reference numerals and the description of the same components is omitted. The head 1007 of FIG. 18 is different from the head 1004 of FIG. 15 in that a recording element 7b does not have a radiating layer on the surface of the main magnetic pole 204 facing the side of the second auxiliary magnetic pole 206b but has a heat transmitting member 2073 interposed between the two radiating layers 207 and 207′ and the slider 2, in the head 1007 of FIG. 18. In this case, the heat transmitting member 2073 is formed of the same material as the two radiating layers 207 and 207′ of FIG. 18. In FIG. 18, the radiating layer 207 that is provided on the surface of the main magnetic pole 204 facing the side of the second auxiliary magnetic pole 206b is divided by the heat transmitting member 2073, but this is because FIG. 18 is the cross-sectional view. In actuality, the radiating layer 207 is disposed to expand in a vertical direction in FIG. 18 to surround the heat transmitting member 2073, and covers the surface of the main magnetic pole 204 that faces the side of the second auxiliary magnetic pole 206b.

In the head 1007 of FIG. 18, since the heat transmitting member 2073 is provided between the radiating layers 207 and 207′ and the slider 2, the heat that is transmitted from the radiating layers 207 and 207′ is discharged to the slider 2 by the heat transmitting member 2073. As a result, the slider 2 is likely to thermally expand. However, since the heat capacity of the slider 2 is larger than those of the radiating layers 207 and 207′, in the head 1007 of FIG. 18, the heat is likely to be transmitted from the peripheral portion of the recording element 7b to the slider 2, and a diffusion speed of the heat from the peripheral portion of the recording element 7b is improved.

In the eighth embodiment, the heat transmitting member 2073 is provided in the head 1007 that has the recording element 7b of the helical coil system. However, in the basic form of the magnetic head and the basic form of the information storage apparatus, the heat transmitting member maybe interposed between the radiating layers 107 and 107′ and the slider 2 in the head 1007 that has the recording element 3b of the double coil system of FIG. 14. That is, the head slider that comprises the head of the double coil system where the heat transmitting member is provided and the slider 2 is one embodiment of the magnetic head with respect to the basic form, and the HDD (equal to the HDD 10 according to the first embodiment, except for the head slider) having the head slider is one embodiment (ninth embodiment) of the information storage apparatus with respect to the basic form. The ninth embodiment is substantially the same as the eighth embodiment, except that the recording element 3b is the recording element of the double coil system. Therefore, the detailed description of the ninth embodiment is omitted.

The various embodiments have been described.

In the above description, as the recording element in the head, the recording element of the double coil system (for example, recording element 1b according to the first embodiment illustrated in FIG. 6) or the recording element of the helical coil system (for example, recording element 2b according to the second embodiment illustrated in FIG. 9) is used. However, in the basic form of the magnetic head or the basic form of the information storage apparatus, a recording element of a single magnetic pole type having only one auxiliary magnetic pole may be used.

In general, on the surface of the auxiliary magnetic pole that faces the side of the coil, a large overcurrent is generated as compared to the surface of the auxiliary magnetic pole that does not face the side of the coil, and the amount of heat generated is also large. According to one of the aforementioned embodiment, the radiating layer is provided between the auxiliary magnetic pole and the coil, and the heat that is generated on the surface of the auxiliary magnetic pole facing the side of the coil is discharged from the auxiliary magnetic pole to the outside of the auxiliary magnetic pole by the radiating layer. For this reason, according to the one of the embodiment, as compared with the case where the radiating layer is provided at the side opposite to the side of the coil with respect to the auxiliary magnetic pole, the heat due to the overcurrent easily diffuses, and a magnetic head where the peripheral portion of the auxiliary magnetic pole is difficult to protrude to the storage medium due to the heat is realized.

Further, in general, in the coil (so-called helical coil) that is composed of the spirally wound wining, the large overcurrent is generated on the surface of the main magnetic pole linked with the coil, and the amount of heat generated is also large. According to one of the aforementioned embodiment of the second magnetic head, the radiating layer is provided between the main magnetic pole and the coil, and the heat that is generated on the surface of the main magnetic pole is discharged from the main magnetic pole to the outside of the main magnetic pole by the radiating layer. For this reason, according to the one of the aforementioned embodiment, as compared with the case where the radiating layer is provided at the side opposite to the side of the coil with respect to the auxiliary magnetic pole, the heat due to the overcurrent easily diffuses, and a magnetic head where the peripheral portion of the main magnetic pole is difficult to protrude to the storage medium due to the heat is realized.

The information storage apparatus according to one of the aforementioned embodiment includes the aforementioned first magnetic head. For this reason, an information storage apparatus where the peripheral portion of the main magnetic pole is difficult to protrude to the storage medium due to the heat and the possibility of the storage medium being damaged due to a contact between the storage medium and the magnetic head is low is realized.

As described above, according to the aforementioned embodiment of the magnetic head and the information storage apparatus, the peripheral portion of the recording element can be suppressed from protruding by the heat generated due to the overcurrent.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic head, comprising:
a coil configured to be supplied with current;
a main magnetic pole configured to be disposed along one surface of the coil and extend in a direction orthogonal to a floating surface from the floating surface;
at least one auxiliary magnetic pole configured to be disposed along other surface of the coil and parallel to the main magnetic pole;
a connecting portion configured to be linked with the coil and connect the main magnetic pole and the auxiliary magnetic pole; and
a radiating layer configured to be disposed between the coil and the auxiliary magnetic pole and have larger thermal conductivity than the auxiliary magnetic pole.

2. The magnetic head of claim 1,
wherein the coil is a double coil having two coil portions differing from each other in a winding direction of a winding constituting the coil,
the at least one auxiliary magnetic pole faces the main magnetic pole with the winding constituting one of the two coil portions therebetween, and
the radiating layer is provided on a surface of the auxiliary magnetic pole facing the main magnetic pole.

3. The magnetic head of claim 1, further comprising:
a magnetic head substrate configured to hold the coil, the main magnetic pole, the auxiliary magnetic pole, and the connecting portion; and
a heat transmitting member configured to be interposed between the radiating layer and the magnetic head substrate.

4. The magnetic head of claim 1, wherein
the auxiliary magnetic pole is configured to include a plurality of magnetic poles arranged in a direction along the floating surface, and
a second radiating layer is provided on one surface of one of the magnetic poles arranged on the most end side among the magnetic poles, the one surface of the one of the magnetic poles facing a direction opposite to a direction to which other surface of the one of the magnetic poles opposite to an adjacent magnetic pole faces.

5. The magnetic head of claim 1, further comprising:
a magnetic head substrate configured to hold the coil, the main magnetic pole, the auxiliary magnetic pole, and the connecting portion,
wherein the radiating layer is formed of a material that has a smaller thermal expansion coefficient than the magnetic head substrate.

6. The magnetic head of claim 5, wherein the radiating layer is formed of a material containing at least one of silicon carbide, tungsten, aluminum nitride, and molybdenum.

7. A magnetic head, comprising:
a coil configured to be supplied with current and composed of a spirally wound winding;
a main magnetic pole configured to be linked with the coil and extend in a direction orthogonal to a floating surface from the floating surface;
at least two auxiliary magnetic poles configured to face the main magnetic pole with a portion of the winding constituting the coil therebetween and be disposed parallel to the main magnetic pole;
a connecting portion configured to connect the main magnetic pole and the auxiliary magnetic poles; and
a radiating layer configured to be disposed between the coil and the main magnetic pole and have larger thermal conductivity than the main magnetic pole.

8. The magnetic head of claim 7, further comprising:
a magnetic head substrate configured to hold the coil, the main magnetic pole, the auxiliary magnetic poles, and the connecting portion; and
a heat transmitting member configured to be interposed between the radiating layer and the magnetic head substrate.

9. The magnetic head of claim 7, wherein
the auxiliary magnetic poles are configured to include a plurality of magnetic poles arranged in a direction along the floating surface, and
a second radiating layer is provided on one surface of one of the magnetic poles arranged on the most end side among the magnetic poles, the one surface of the one of the magnetic poles facing a direction opposite to a direction to which other surface of the one of the magnetic poles opposite to an adjacent magnetic pole faces.

10. The magnetic head of claim 7, further comprising:
a magnetic head substrate configured to hold the coil, the main magnetic pole, the auxiliary magnetic poles, and the connecting portion,
wherein the radiating layer is formed of a material that has a smaller thermal expansion coefficient than the magnetic head substrate.

11. The magnetic head of claim 10, wherein the radiating layer is formed of a material containing at least one of silicon carbide, tungsten, aluminum nitride, and molybdenum.

12. An information storage apparatus, comprising:
a storage medium; and
a magnetic head configured to record information represented by magnetization on the storage medium,
wherein the magnetic head comprises:
a coil configured to be supplied with current;
a main magnetic pole configured to be disposed along one surface of the coil and extend in a direction orthogonal to a floating surface from the floating surface;
at least one auxiliary magnetic pole configured to be disposed along the other surface of the coil and parallel to the main magnetic pole;
a connecting portion configured to be linked with the coil and connect the main magnetic pole and the auxiliary magnetic pole; and
a radiating layer configured to be disposed between the coil and the auxiliary magnetic pole and have larger thermal conductivity than the auxiliary magnetic pole.
